(19) United States
(12) Patent Application Publication
(10) Pub. No.: US 2004/0052579 A1
(43) Pub. Date: Mar. 18, 2004

(54) Tether clip system

(76) Inventors: Kraig D. Draggoo, Oakland, MI (US); Eric D. Hyp, Aspers, PA (US); Loc B. Tieu, Exton, PA (US); David A. Minnich, Wilmington, DE (US); William E. Sokurenko, Glen Mills, PA (US)

Correspondence Address: PAUL AND PAUL, 2900 TWO THOUSAND MARKET STREET, PHILADELPHIA, PA, 19103, US

(21) Appl. No.: 10/243,803

(22) Filed: Sep. 13, 2002

(51) Int. Cl. B25G 3/18

(52) U.S. Cl. 403/326

(57) ABSTRACT

Reliable and durable tether clips that continue to tether two panels together while allowing for a controlled displacement between the two panels in response to a predetermined force are disclosed. The tether clips according to the present invention include a first retaining means near a first end that is adapted to be securable to a first panel, a second retaining means that is engageable with the second panel and limits the relative separation between the panels, and a releasable fastener means intermediate the first and second retaining means that normally maintains the two panels in a closed configuration relative to one another but that releases at least one of the panels relative to the other panel in response to a predetermined force tending to separate the panels.

### BACKGROUND OF THE INVENTION

1. Field of Invention

This invention relates generally to a panel fastener or clip that normally fastens two panels together but allows for a predetermined displacement between the panels in response to a predetermined force applied to the panels.

2. Brief Description of the Related Art

In many applications the need arises to fasten one panel to another. For example, in the automotive industry the interior door panels of the vehicle must be securely fastened to the sheet metal forming part of the vehicle door. Many fasteners for this purpose have been proposed in the art. Examples of such panel fasteners can be seen in U.S. Pat. Nos. 5,758,987 and 6,042,296. However, there remains a need in the art for panel fasteners that, while securing two panels together under normal circumstances, will also allow for a controlled displacement between the two panels in response to the application of a predetermined force. An example, of an application requiring this type of fastener is in cars having side airbags that are concealed by the interior door panels. In such cars, when the side airbag inflates in an accident, the panels must be allowed to be displaced relative to one another to allow the airbag to be deployed properly, however, the panels should not be allowed to become completely disconnected. If an interior panel is allowed to separate completely upon deployment of the airbag, then the loose panel could act as a projectile that can cause injury to a vehicle's occupants. Furthermore, by limiting the displacement between the panels, reinstallation of the panel subsequent to the deployment of the airbag becomes much easier. The need persists in the art for a reliable and durable panel fastener or clip that will continue to tether two panels together while allowing for a controlled displacement between the two panels in response to a predetermined force.

### SUMMARY OF THE INVENTION

The present invention is directed to reliable and durable panel fasteners or tether clips that continue to tether two panels together while allowing for a controlled displacement between the two panels in response to a predetermined force. The panel fasteners or tether clips according to the present invention include a first retaining means near a first end that is adapted to be securable to a first panel, a second retaining means that is engageable with the second panel and limits the relative separation between the panels, and a releasable fastener means intermediate the first and second retaining means that normally maintains the two panels in a closed configuration relative to one another but that releases at least one of the panels relative to the other panel in response to a predetermined force tending to separate the panels. The type of panel fasteners that, while securing two panels together under normal circumstances, will also allow for a controlled displacement between the two panels in response to the application of a predetermined force, are referred to herein as tether clips.

### BRIEF DESCRIPTION OF THE DRAWINGS

FIGS. 1-3 are views of a first embodiment of a tether clip system according to the present invention.

FIGS. 4-8 are views of a second embodiment of a tether clip system according to the present invention.

Like reference numerals indicate like elements throughout the several views.

### DETAILED DESCRIPTION OF THE INVENTION

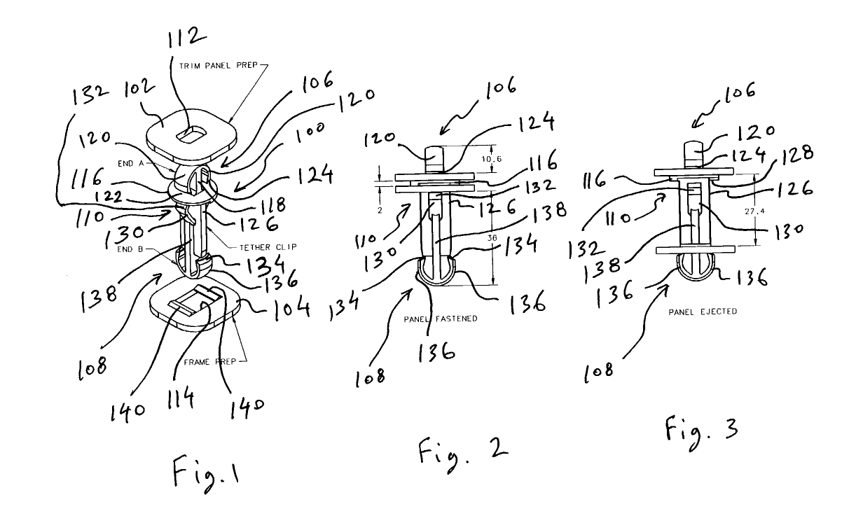

Referring to FIGS. 1-3, an illustrative example of a tether clip system according to the present invention can be seen. The tether clip system of FIGS. 1-3 includes a tether clip 100 for fastening a first panel 102 relative to a second pane 104. The tether clip 100 comprises a first retaining means 106 adapted to be securable to the first panel 102; a second retaining means 108 that is engageable with the second panel 104 and limits the relative separation between the first and second panels; and a releasable fastener means 110 intermediate said first and second retaining means 106 and 108. The releasable fastener means 110 is adapted to be releasably engageable with the second panel 104. The releasable fastener means 110 is adapted to normally maintain the first and second panels in a closed configuration relative to one another as shown in FIG. 2. The releasable fastener means 110 is designed to release the second panel 104 in response to a force tending to separate the first and second panels that is greater than a first predetermined value, thus allowing the panel 104 to move to the position shown in FIG. 3.

The first panel 102 has a first opening 112 and the second panel 104 has a second opening 114. The first retaining means 106 comprises a shoulder 116; a first body portion 118 projecting from a first side of said shoulder 116 and having an end distal from said shoulder 116. The first body portion 118 has a first longitudinal axis that is coincident with the longitudinal axis of the tether clip 100. The first retaining means 106 further includes a first pair of resilient snap legs 120 attached to said first body portion 118 proximate said end of said first body portion distal from said shoulder 116.

Each of said first pair of resilient snap legs 120 has a proximal end and a distal end. Each of said first pair of resilient snap legs 120 is attached to said first body portion 118 proximate said proximal end of each of said first pair of resilient snap legs. Each of said first pair of resilient snap legs 120 extends from said proximal end thereof generally in a direction toward a plane coincident with said first side 122 of said shoulder 116 and at least in part diverging away from said longitudinal axis of the tether clip 100.

Each of said first pair of resilient snap legs 120 has at least one notch 124 provided proximate said distal end of each of said first pair of resilient snap legs 120. When said first retaining means 106 is secured to the first panel 102, at least a portion of the first panel 102 proximate the first opening 112 is captured between at least a portion of said shoulder 116 and said notch 124 in each of said first pair of resilient snap legs 120 to thereby secure the tether clip 100 to the first panel 102.

The releasable fastener means 110 comprises a second body portion 126 projecting from a second side 128 of said shoulder 116 and has an end distal from said shoulder 116. The second body portion 126 has a second longitudinal axis in line with said first longitudinal axis and thus coincident with the longitudinal axis of the tether clip 100. The releasable fastener means 110 further comprises a second pair of resilient snap legs 130 attached to said second body portion 126 proximate said end of said second body portion distal from said shoulder 116.

Each of said second pair of resilient snap legs 130 has a proximal end and a distal end. Each of said second pair of resilient snap legs 130 is attached to said second body portion 126 proximate said proximal end of each of said second pair of resilient snap legs 130, and a portion of each of said second pair of resilient snap legs 130 extends from proximate said proximal end of each of said second pair of resilient snap legs generally in a direction toward a plane coincident with said second side 128 of said shoulder and that diverges away from said longitudinal axis of the tether clip 100.

Each of said second pair of resilient snap legs 130 has a surface portion 132 proximate said distal end thereof that converges toward said longitudinal axis of the tether clip with decreasing distance from said second side 128 of said shoulder 116. When said releasable fastener means 110 is secured to the second panel 104 (as shown in FIGS. 2, 7, and 8) at least a portion of the second panel 104 proximate the second opening 114 is captured between at least a portion of said shoulder 116 and said surface portion 132 proximate said distal end of each of said second pair of resilient snap legs 130 to thereby secure the second panel 104 to the first panel 102 in the closed configuration of FIGS. 2, 7, and 8. The surface portion 132 proximate said distal end of each of said second pair of resilient snap legs 130 cooperates with the portion of the second panel 104 proximate the second opening 114 to bend said second pair of resilient snap legs 130 toward said longitudinal axis of the tether clip to thereby allow the second panel 104 to be released from said releasable fastener means 110 to the positions shown in FIGS. 3, 5 and 6 when said releasable fastener means is initially secured to the second panel 104 and a force tending to move the first and second panels apart and of a magnitude greater than said first predetermined value is applied.

The said second retaining means 108 comprises a third body portion 138 attached to said releasable fastener means 110 proximate said proximal end of each of said second pair of resilient snap legs 130. The third body portion 138 has an end distal from said releasable fastener means 110. The third body portion 138 has a third longitudinal axis in line with said second longitudinal axis and the longitudinal axis of the tether clip 100. The third body portion 138 has a third pair of resilient snap legs 136 attached to said third body portion 138 proximate said end of said third body portion distal from said releasable fastener means 110.

Each of said third pair of resilient snap legs 136 has a proximal end and a distal end. Each of said third pair of resilient snap legs 136 is attached to said third body portion 138 proximate said proximal end of each of said third pair of resilient snap legs 136. Each of said third pair of resilient snap legs 136 extends from said proximal end thereof generally in a direction toward a plane coinciding with said second side 128 of said shoulder 116 and at least in part diverges away from said longitudinal axis of the tether clip.

Each of said third pair of resilient snap legs 136 has at least one notch 134 provided proximate said distal end of each of said third pair of resilient snap legs 136. The notch 134 in each of said third pair of resilient snap legs 136 can engage at least a portion of the second panel 104 proximate the second opening 114 to limit the separation between said first and second panels 102 and 104 when the second panel 104 is released by said releasable fastener means 110 (as shown in FIGS. 3, 5, and 6) after being initially secured to the first panel 102 by said releasable fastener means 110. The snap legs 136 will maintain the panel 104 in the position shown in FIGS. 3, 5, and 6 as long as any applied force tending to move the first and second panels 102 and 104 further apart is of a magnitude less than a second predetermined value.

In the tether clip 100, wherein a medial plane passing through both said second pair of resilient snap legs 130 is substantially at a right angle measured about said longitudinal axis of the tether clip 100 relative to a medial plane passing through both said third pair of resilient snap legs 136.

The tether clip system of FIGS. 1-3 also includes up turned portions 140. The first pair of regions 140 of said portion of the second panel 104 adjacent said second opening 144 are located on opposite sides of said second opening 114 along a first axis. Each of said first pair of regions 140 at least in part project outward from a first side of the second panel 104 facing the first panel 102 to form a pair of ramped surfaces inclined relative to a medial plane of said portion of the second panel 104 having said second opening 114 therein. The regions 140 present a smooth surface for engagement with the snap legs 130 when the second pair of resilient snap legs 130 engage with the portions of the second panel 104 proximate the second opening 114 to bend said second pair of resilient snap legs 130 toward said longitudinal axis of the tether clip to thereby allow the second panel 104 to be released from said releasable fastener means 110. This feature provides better control of the force required to release the panel 104 from the releasable fastener means 110 and helps prevent snags.

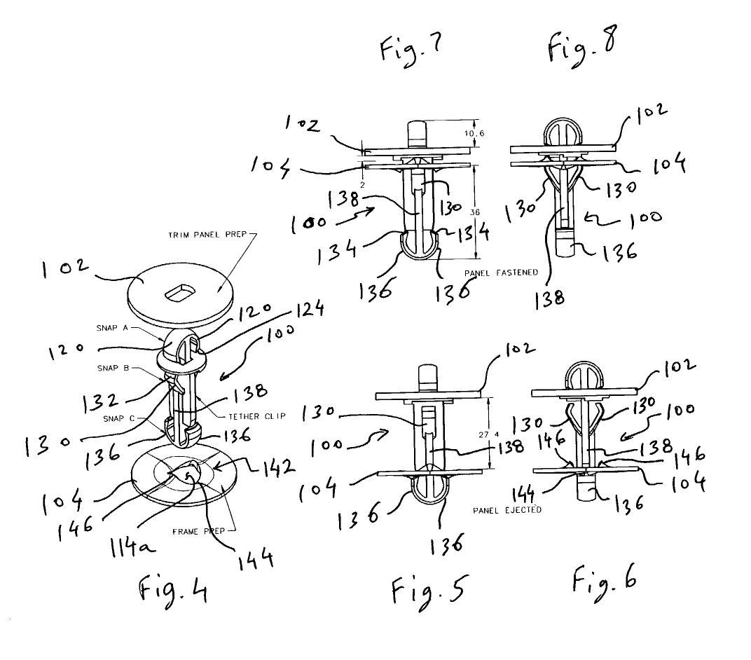

The tether clip system of FIGS. 4-8 is identical to that of FIGS. 1-3 except for the differences noted below. The tether clip system of FIGS. 4-8 has a means 142 for increasing retention strength between said second retaining means 108 and the second panel 104 when the second panel has been released from said releasable fastener means 110.

In the tether clip system of FIGS. 4-8, the means 142 for increasing retention strength comprises a portion of the second panel 104 having a second opening 114a therein. The portion of the second panel 104 surrounding the second opening 114a has a first pair of regions 146 that are located on opposite sides of said second opening 114a along a first axis. Each of said first pair of regions 146 at least in part project outward from a first side of the second panel 104 facing the first panel 102 to form a pair of ramped surfaces inclined relative to a medial plane of said portion of the second panel 104 having said second opening 114a therein. A second pair of regions 144 of said portion of the second panel 104 adjacent said second opening 114a are also located on opposite sides of said second opening 114a, but along a second axis that is perpendicular to said first axis between the regions 146 in plan view. Each of said second pair of regions 144 at least in part project outward from a second side of the second panel opposite the first side of the second panel 104 and provide a catch that more positively engages the snap legs 136 as shown in FIGS. 5 and 6. The means 142 for increasing retention strength comprises the regions 144.

As an example of the use of the tether clip 100, Panel 102 may be the interior panel of the door of a motor vehicle and the panel 104 may be the sheet metal of the door. The retaining means 106 is attached to the panel 102 by pressing in the portion 118 into the hole 112. The sides of the hole 112 deform the snap legs 120. Once the notches 124 clear the panel 102, the snap legs 120 snap open behind the panel 102 to secure the tether clip 100 to the panel 102. Once the airbag is in place the second retainer 108 is pushed through the hole 114 or 114a. As with snap legs 120, snap legs 136 deform by the action of the sides of the hole 114 or 114a to allow the snap legs 136 to pass through the hole 114 or 114a and open up behind the panel 104 to prevent the tether clip 100 from being pulled completely out of the hole 114 or 114a unless a force exceeding the second predetermined force is applied to the panels. The panel 104 can now move freely between the retaining mean 108 and the releasable fastener means 110. To secure the panel 102 in its normal position, the releasable fastener means 110 is snapped into the hole 114 or 114a. The snap legs 130 deform by the action of the sides of the hole 114 or 114a to allow the snap legs 130 to pass through the hole 114 or 114a and open up behind the panel 104 to secure the panel 102 in the normal position of FIGS. 2, 7, and 8.

When the airbag inflates, a force in excess of the first predetermined value and tending to pull the panels apart is created. The ramped surfaces 132 catch the edges of the hole 114 or 114a in a cam action that bends the snap legs 130 toward the longitudinal axis of the tether clip 100. This allows the insertion process of the releasable fastener means 110 to be reversed and for the releasable fastener means 110 to release the panel 104. As the airbag inflates further, the snap legs 136 catch the panel 104 and prevent the panel 102 from being pulled completely free from the vehicle door panel 104. Thus, an opening between panels 102 and 104 can be provided for the proper inflation of the airbag without allowing the panel 102 to become a projectile. The snap legs 136 are designed such that they fail at forces greater than a second predetermined value that is higher than the forces encountered during airbag deployment. The second predetermined value is usually greater that the first predetermined value. The first predetermined value can range from 10 to 50 lbs., and preferably from about 20 to about 30 lbs., and even more preferably from 20 to 30 lbs. The second predetermined value can be in the range of 75 lbs. and greater, and preferably is in the range of about 150 lbs. and greater, and even more preferably about 150 lbs. The travel between the panels 102 and 104 during airbag deployment is about 25 mm.

It is to be understood that the present invention is not limited to the embodiments described above, but includes any and all embodiments within the scope of the appended claims. Furthermore, it is to be understood that the embodiments of the present invention disclosed above are susceptible to various modifications, changes and adaptations by those skilled in the art, without departing from the spirit and scope of the invention.

1. A tether clip for fastening a first panel relative to a second panel, the tether clip comprising:
a first retaining means adapted to be securable to the first panel;
a second retaining means that is engageable with the second panel and limits the relative separation between the first and second panels; and
a releasable fastener means intermediate said first and second retaining means and being adapted to be releasably engageable with the second panel, said releasable fastener means being adapted to normally maintain the first and second panels in a closed configuration relative to one another, and wherein said releasable fastener means releases the second panel in response to a force tending to separate the first and second panels that is greater than a first predetermined value.

2. The tether clip according to claim 1, wherein the first panel has a first opening, the second panel has a second opening, and said first retaining means comprises:
a shoulder;
a first body portion projecting from a first side of said shoulder and having an end distal from said shoulder, said first body portion having a first longitudinal axis; and
a first pair of resilient snap legs attached to said first body portion proximate said end of said first body portion distal from said shoulder.

3. The tether clip according to claim 2, wherein each of said first pair of resilient snap legs has a proximal end and a distal end, each of said first pair of resilient snap legs is attached to said first body portion proximate said proximal end of each of said first pair of resilient snap legs, and each of said first pair of resilient snap legs extends from said proximal end thereof generally in a direction toward a plane coincident with said first side of said shoulder and at least in part diverging away from said first longitudinal axis.

4. The tether clip according to claim 3, wherein each of said first pair of resilient snap legs has at least one notch provided proximate said distal end of each of said first pair of resilient snap legs, wherein when said first retaining means is secured to the first panel at least a portion of the first panel proximate the first opening is captured between at least a portion of said shoulder and said notch in each of said first pair of resilient snap legs to thereby secure the tether clip to the first panel.

5. The tether clip according to claim 4, wherein said releasable fastener means comprises:
a second body portion projecting from a second side of said shoulder and having an end distal from said shoulder, said second body portion having a second longitudinal axis in line with said first longitudinal axis; and
a second pair of resilient snap legs attached to said second body portion proximate said end of said second body portion distal from said shoulder.

6. The tether clip according to claim 5, wherein each of said second pair of resilient snap legs has a proximal end and a distal end, each of said second pair of resilient snap legs is attached to said second body portion proximate said proximal end of each of said second pair of resilient snap legs, and a portion of each of said second pair of resilient snap legs extends from proximate said proximal end of each of said second pair of resilient snap legs generally in a direction toward a plane coincident with said second side of said shoulder and diverging away from said second longitudinal axis.

7. The tether clip according to claim 6, wherein each of said second pair of resilient snap legs has a surface portion proximate said distal end thereof that converges toward said second longitudinal axis with decreasing distance from said second side of said shoulder, wherein when said releasable fastener means is secured to the second panel at least a portion of the second panel proximate the second opening is captured between at least a portion of said shoulder and said surface portion proximate said distal end of each of said second pair of resilient snap legs to thereby secure the second panel to the first panel in the closed configuration, and wherein said surface portion proximate said distal end of each of said second pair of resilient snap legs cooperates with the portion of the second panel proximate the second opening to bend said second pair of resilient snap legs toward said second longitudinal axis to thereby allow the second panel to be released from said releasable fastener means when said releasable fastener means is initially secured to the second panel and a force tending to move the first and second panels apart and of a magnitude greater than said first predetermined value is applied.

8. The tether clip according to claim 7, wherein said second retaining means comprises:
a third body portion attached to said releasable fastener means proximate said proximal end of each of said second pair of resilient snap legs, said third body portion having an end distal from said releasable fastener means, said third body portion having a third longitudinal axis in line with said second longitudinal axis; and
a third pair of resilient snap legs attached to said third body portion proximate said end of said third body portion distal from said releasable fastener means.

9. The tether clip according to claim 8, wherein each of said third pair of resilient snap legs has a proximal end and a distal end, each of said third pair of resilient snap legs is attached to said third body portion proximate said proximal end of each of said third pair of resilient snap legs, and each of said third pair of resilient snap legs extends from said proximal end thereof generally in a direction toward a plane coinciding with said second side of said shoulder and at least in part diverging away from said third longitudinal axis.

10. The tether clip according to claim 9, wherein each of said third pair of resilient snap legs has at least one notch provided proximate said distal end of each of said third pair of resilient snap legs, wherein said notch in each of said third pair of resilient snap legs can engage at least a portion of the second panel proximate the second opening to limit the separation between said first and second panels when the second panel is released by said releasable fastener means after being initially secured to the first panel by said releasable fastener means and any applied force tending to move the first and second panels further apart is of a magnitude less than a second predetermined value.

11. The tether clip according to claim 10, wherein a medial plane passing through both said second pair of resilient snap legs is substantially at a right angle measured about said third longitudinal axis relative to a medial plane passing through both said third pair of resilient snap legs.

13. A tether clip system for fastening a first panel relative to a second panel, the tether clip system comprising:
a tether clip comprising:
a first retaining means adapted to be securable to the first panel;
a second retaining means that is engageable with the second panel and limits the relative separation between the first and second panels; and
a releasable fastener means intermediate said first and second retaining means and being adapted to be releasably engageable with the second panel, said releasable fastener means being adapted to normally maintain the first and second panels in a closed configuration relative to one another, and wherein said releasable fastener means releases the second panel in response to a force tending to separate the first and second panels that is greater than a first predetermined value; and
means for increasing retention strength between said second retaining means and the second panel after the second panel has been released from said releasable fastener means.

14. The tether clip system according to claim 13, wherein the first panel has a first opening and said means for increasing retention strength comprises:
a portion of the second panel having a second opening therein;
a first pair of regions of said portion of the second panel adjacent said second opening, said first pair of regions being located on opposite sides of said second opening along a first axis, each of said first pair of regions at least in part projecting outward from a first side of the second panel facing the first panel to form a pair of ramped surfaces inclined relative to a medial plane of said portion of the second panel having said second opening therein; and
a second pair of regions of said portion of the second panel adjacent said second opening, said second pair of regions being located on opposite sides of said second opening along a second axis, said second axis being perpendicular to said first axis in plan view, each of said second pair of regions at least in part projecting outward from a second side of the second panel opposite the first side of the second panel.

15. The tether clip system according to claim 14, wherein said first retaining means comprises comprises:
a shoulder;
a first body portion projecting from a first side of said shoulder and having an end distal from said shoulder, said first body portion having a first longitudinal axis; and
a first pair of resilient snap legs attached to said first body portion proximate said end of said first body portion distal from said shoulder.

16. The tether clip system according to claim 15, wherein each of said first pair of resilient snap legs has a proximal end and a distal end, each of said first pair of resilient snap legs is attached to said first body portion proximate said proximal end of each of said first pair of resilient snap legs, and each of said first pair of resilient snap legs extends from said proximal end thereof generally in a direction toward a plane coincident with said first side of said shoulder and at least in part diverging away from said first longitudinal axis.

17. The tether clip system according to claim 16, wherein each of said first pair of resilient snap legs has at least one notch provided proximate said distal end of each of said first pair of resilient snap legs, wherein when said first retaining means is secured to the first panel at least a portion of the first panel proximate the first opening is captured between at least a portion of said shoulder and said notch in each of said first pair of resilient snap legs to thereby secure the tether clip to the first panel.

18. The tether clip system according to claim 17, wherein said releasable fastener means comprises:
a second body portion projecting from a second side of said shoulder and having an end distal from said shoulder, said second body portion having a second longitudinal axis in line with said first longitudinal axis; and
a second pair of resilient snap legs attached to said second body portion proximate said end of said second body portion distal from said shoulder.

19. The tether clip system according to claim 18, wherein each of said second pair of resilient snap legs has a proximal end and a distal end, each of said second pair of resilient snap legs is attached to said second body portion proximate said proximal end of each of said second pair of resilient snap legs, and a portion of each of said second pair of resilient snap legs extends from proximate said proximal end of each of said second pair of resilient snap legs generally in a direction toward a plane coincident with said second side of said shoulder and diverging away from said second longitudinal axis.

20. The tether clip system according to claim 19, wherein each of said second pair of resilient snap legs has a surface portion proximate said distal end thereof that converges toward said second longitudinal axis with decreasing distance from said second side of said shoulder, wherein when said releasable fastener means is secured to the second panel at least a portion of the second panel proximate said second opening is captured between at least a portion of said shoulder and said surface portion proximate said distal end of each of said second pair of resilient snap legs to thereby secure the second panel to the first panel in the closed configuration, and wherein said surface portion proximate said distal end of each of said second pair of resilient snap legs cooperates with the portion of the second panel proximate said second opening to bend said second pair of resilient snap legs toward said second longitudinal axis to thereby allow the second panel to be released from said releasable fastener means when said releasable fastener means is initially secured to the second panel and a force tending to move the first and second panels apart and of a magnitude greater than said first predetermined value is applied.

21. The tether clip system according to claim 20, wherein said second retaining means comprises:
a third body portion attached to said releasable fastener means proximate said proximal end of each of said second pair of resilient snap legs, said third body portion having an end distal from said releasable fastener means, said third body portion having a third longitudinal axis in line with said second longitudinal axis; and
a third pair of resilient snap legs attached to said third body portion proximate said end of said third body portion distal from said releasable fastener means.

22. The tether clip system according to claim 21, wherein each of said third pair of resilient snap legs has a proximal end and a distal end, each of said third pair of resilient snap legs is attached to said third body portion proximate said proximal end of each of said third pair of resilient snap legs, and each of said third pair of resilient snap legs extends from said proximal end thereof generally in a direction toward a plane coinciding with said second side of said shoulder and at least in part diverging away from said third longitudinal axis.

23. The tether clip system according to claim 22, wherein each of said third pair of resilient snap legs has at least one notch provided proximate said distal end of each of said third pair of resilient snap legs, wherein said notch in each of said third pair of resilient snap legs can engage at least a portion of the second panel proximate said second opening to limit the separation between said first and second panels when the second panel is released by said releasable fastener means after being initially secured to the first panel by said releasable fastener means and any applied force tending to move the first and second panels further apart is of a magnitude less than a second predetermined value.
